(19) United States
(12) Patent Application Publication
(10) Pub. No.: US 2024/0354224 A1
(43) Pub. Date: Oct. 24, 2024

(54) CONSENSUS BUG DETECTION THROUGH MULTI-TRANSACTION DIFFERENTIAL FUZZING

(71) Applicants: SEOUL NATIONAL UNIVERSITY R&DB FOUNDATION, Seoul (KR); GEORGIA TECH RESEARCH CORPORATION, Atlanta, GA (US)

(72) Inventors: Youngseok Yang, Seoul (KR); Byung-Gon CHUN, Seoul (KR); Taesoo KIM, Atlanta, GA (US)

(21) Appl. No.: 18/571,548

(22) PCT Filed: Jul. 12, 2022
(86) PCT No.: PCT/KR2022/010161

§ 371 Date: Dec. 18, 2023

Related U.S. Application Data
(60) Provisional application No. 63/220,800, filed on Jul. 12, 2021.

(51) Int. Cl. G06F 11/36; G06Q 20/36

(52) U.S. Cl. CPC G06F 11/3636; G06Q 20/3678

(57) ABSTRACT

According to example embodiments, provided are a method and an apparatus for finding consensus bugs using multi-transaction differential fuzzing.

### TECHNICAL FIELD

The present disclosure relates to finding of consensus bugs, and to a method and an apparatus for finding consensus bugs latent in an Ethereum client using multi-transaction differential fuzzing.

### BACKGROUND ART

The following description is only for the purpose of providing background information related to example embodiments of the present disclosure, and the contents to be described do not necessarily constitute related art.

Ethereum is the second-largest blockchain platform next to Bitcoin. In an Ethereum network, decentralized Ethereum clients reach consensus through transitioning to the same blockchain states according to the Ethereum specification.

Consensus bugs refer to bugs that make Ethereum clients transition to incorrect blockchain states and fail to reach consensus with other clients.

The consensus bugs are extremely rare, but may be exploited for network split and theft when triggered once, which may cause reliability and security-critical issues in the Ethereum ecosystem. Particularly, since a hard fork and block loss of a mainnet occur, prevention thereof is required first.

On the other hand, there are attempts to find consensus bugs by using a fuzzing technique, and some known fuzzers have succeeded in finding some consensus bugs. Fuzzing is a technique to find bugs by iteratively creating random input values and injecting the created random input values into a target program. Existing Ethereum fuzzing technology creates one blockchain state and a single transaction, and injects the blockchain state and the transaction into multiple clients to check whether to reach consensus with each other (Differential Fuzzing).

However, such existing fuzzing technology cannot explore a deep client state. This is because, among client code paths, there are code paths that are triggered only when multiple transactions are executed. As a result, a blockchain state model used in existing fuzzers falls short to cover the full search space to find consensus bugs, and as a result, there is a limit to miss consensus bugs out of such limited coverage.

Therefore, there is a need for a method to effectively finding a code path that can cause latent consensus bugs in the full search space in advance.

The prior arts described above may be technical information retained to derive the present disclosure or acquired in the process of deriving the present disclosure by the present inventors, and thus are not necessarily known arts disclosed to the general public before the filing of the present application.

### DISCLOSURE OF INVENTION

### Technical Problem

An object of the present disclosure is to provide a method and an apparatus capable of efficiently finding latent consensus bugs in a full search space.

Another object of the present disclosure is to provide a multi-transaction differential fuzzing method for finding consensus bugs.

The objects of the present disclosure are not limited to the above-mentioned objects, and other objects and advantages of the present disclosure, which are not mentioned, will be understood through the following description, and will become apparent from example embodiments of the present disclosure. In addition, it will be appreciated that the objects and advantages of the present disclosure will be easily realized by those skilled in the art based on the appended claims and a combination thereof.

### Solution to Problem

According to an aspect of the present disclosure, there is provided a method for finding consensus bugs including creating, by a processor, a series of mutated transactions in which at least some of a series of transitions are altered by executing at least one mutation process with respect to a test case including the series of transactions, providing, by the processor, the series of mutated transactions to multiple Ethereum clients, acquiring a series of transition blockchain states associated with a state transition from an initial blockchain state of each Ethereum client by the series of mutated transactions from each of the multiple Ethereum clients, and determining consensus information among the multiple Ethereum clients based on the series of transition blockchain states.

According to another aspect of the present disclosure, there is provided an apparatus for finding consensus including a memory configured to store at least one instruction, and a processor, in which when the at least one instruction is executed by the processor, the processor is configured to create a series of mutated transactions in which at least some of a series of transitions are altered by executing at least one mutation process with respect to a test case including the series of transactions, provide the series of mutated transactions to multiple Ethereum clients, acquire a series of transition blockchain states associated with a state transition from an initial blockchain state of each Ethereum client by the series of mutated transactions from each of the multiple Ethereum clients, and determine consensus information among the multiple Ethereum clients based on the series of transition blockchain states.

Other aspects, features, and advantages than those described above will become apparent from the following drawings, claims, and detailed description of the present disclosure.

### Advantageous Effects of Invention

According to the example embodiments, it is possible to provide a method and an apparatus for finding consensus bugs using multi-transaction differential fuzzing.

According to the example embodiments, it is possible to find a greater number of Ethereum bugs by fuzzing multiple transactions to search for deeper client states.

The effects of the present disclosure are not limited to those mentioned above, and other effects not mentioned can be clearly understood by those skilled in the art from the following description.

### BRIEF DESCRIPTION OF DRAWINGS

The foregoing and other objects, features, and advantages of the disclosure, as well as the following detailed description of the example embodiments, will be better understood when read in conjunction with the accompanying drawings. For the purpose of illustrating the disclosure, there is shown in the drawings an exemplary embodiment that is presently preferred, it being understood, however, that the disclosure is not intended to be limited to the details shown because various modifications and structural changes may be made therein without departing from the spirit of the disclosure and within the scope and range of equivalents of the claims. The use of the same reference numerals or symbols in different drawings indicates similar or identical items.

FIG. 1 schematically illustrates an Ethereum blockchain configuration.

FIG. 2 is a diagram for schematically describing finding of consensus bugs according to an example embodiment.

FIG. 3 is a block diagram of an apparatus for finding consensus bugs according to an example embodiment.

FIG. 4 is a flowchart of a method for finding consensus bugs according to an example embodiment.

FIG. 5A is an additional flowchart of a method for finding consensus bugs according to an example embodiment.

FIG. 5B is an additional flowchart of a method for finding consensus bugs according to an example embodiment.

FIG. 6 is a diagram for exemplarily describing finding of consensus bugs according to an example embodiment.

FIG. 7 illustrates a data structure of an exemplary test case for finding consensus bugs according to an example embodiment.

FIG. 8 illustrates an exemplary mutation process for finding consensus bugs according to an example embodiment.

FIG. 9 is a diagram for describing an exemplary process of finding consensus bugs by the method for finding the consensus bugs according to an example embodiment.

FIG. 10 is a diagram for describing an exemplary process of finding consensus bugs by the method for finding the consensus bugs according to an example embodiment.

### BEST MODE FOR CARRY OUT THE INVENTION

The present disclosure may be embodied in various different forms and is not limited to the example embodiments set forth herein. Hereinafter in order to clearly describe the present disclosure, parts that are not directly related to the description are omitted. However, in implementing an apparatus or a system to which the spirit of the present disclosure is applied, it is not meant that such an omitted configuration is unnecessary. Further, like reference numerals refer to like elements throughout the specification.

In the following description, although the terms “first”, “second”, and the like may be used herein to describe various elements, these elements should not be limited by these terms. These terms may be only used to distinguish one element from another element. Also, in the following description, the singular expression includes plural expression unless the context clearly dictates otherwise.

In the following description, it will be understood that terms such as “comprising,”, “having,” and the like are intended to specify the presence of stated feature, integer, step, operation, component, part or combination thereof, but do not preclude the presence or addition of one or more other features, integers, steps, operations, components, parts or combinations thereof. Hereinafter, the present disclosure will be described in detail with reference to the accompanying drawings.

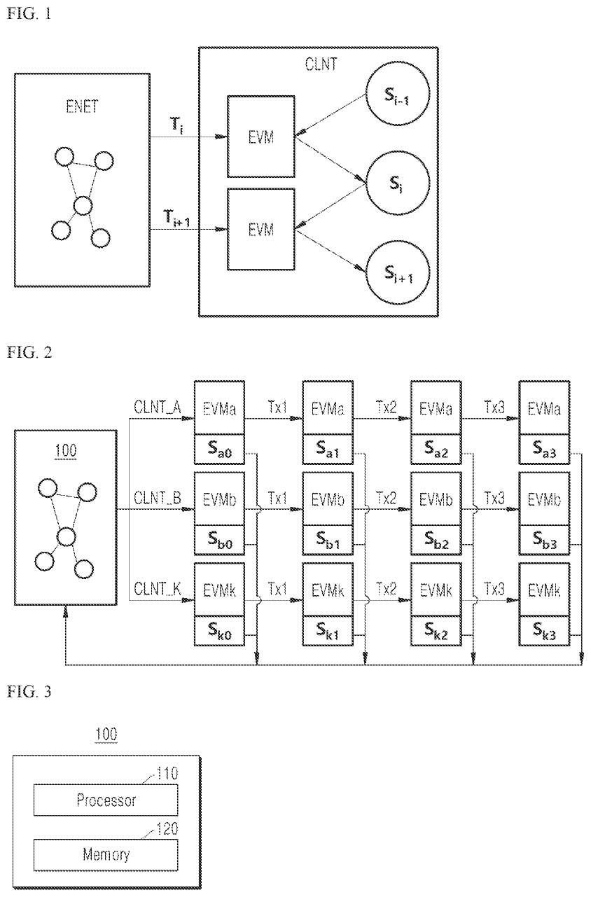

FIG. 1 schematically illustrates an Ethereum blockchain configuration.

An Ethereum network ENET consists of multiple decentralized Ethereum clients CLNTs. The clients communicate with each other to reach consensus with each other through transitioning to the same blockchain state.

The blockchain state transformation method follows the Ethereum Specification. Decentralized peer-to-peer Ethereum clients CLNTs implement the Ethereum virtual machine (EVM) specification.

The EVM is a Turing complete machine that specifies how an Ethereum blockchain state is altered through transaction recorded on an Ethereum block. Here, the Ethereum blockchain state means a set of Ethereum accounts. The Ethereum account has an address and holds a balance of Ether ETH, Ethereum cryptocurrency.

There are two types of accounts in the Ethereum blockchain. One type is an externally owned account (EOA) owned by an Ethereum user, and the other type is a smart contract account which is owned by a code and has a key-value storage. Additionally, the EVM may provide precompiled contracts that perform specialized operations at fixed addresses.

The Ethereum transactions include contract creation transactions that create new smart contracts and message call transactions that can invoke smart contracts.

The Ethereum client CLNT is a software program that reaches consensus in the same blockchain state within the Ethereum network, and is an instance of EVM implemented to conform to the Ethereum EVM specification. The Ethereum clients CLNTs implement the EVM with a programming language such as Go and Rust. For example, for the Ethereum clients, Geth (written in Golang language) and OpenEthereum (written in Rust language) are the most used.

The EVM executes transactions (e.g., Ti, Ti+1) for the accounts associated with the Ethereum clients CLNTs. The EVM executes transactions by processing Ethereum bytecode instructions and transitions the blockchain states of the clients.

For example, the Ethereum client CLNT executes a transaction Ti to transition from a blockchain state Si−1 to a blockchain state Si. The transition from the blockchain state Si to a blockchain state Si+1 may be made by a subsequent transaction Ti+1.

FIG. 2 is a diagram for schematically describing finding of consensus bugs according to an example embodiment.

An apparatus 100 for finding consensus bugs according to an example embodiment provides test cases to multiple Ethereum clients (e.g., CLNT_A, CLNT_B, and CLNT_K). Here, the test case includes a series of transactions. Although three clients and three times of transactions are illustrated in FIG. 2, it is exemplary and not limited thereto, and more or fewer clients and transactions are possible.

Each of the Ethereum clients CLNT_A, CLNT_B, and CLNT_K executes a series of transactions included in the test case and provides the result to the apparatus 100 for finding the consensus bugs.

The apparatus 100 for finding the consensus bugs determines consensus information by comparing test case execution results acquired from each of the Ethereum clients CLNT_A, CLNT_B, and CLNT_K.

The test case execution result means a final blockchain state of the Ethereum client by the transaction.

Meanwhile, each client has a client program state. Here, the client program state is a client program variable, which corresponds to a client code.

In the example of FIG. 2, a client A CLNT_A transitions to a blockchain state Sa1 of the client A CLNT_A by a first transaction Tx1. Subsequently, the client A CLNT_A transitions to a blockchain state Sa2 of the client A CLNT_A by a second transaction Tx2, and transitions to a blockchain state Sa3 of the client A CLNT A after a third transition Tx3 is completed.

Similarly, a client B CLNT_B transitions to blockchain states Sb1, Sb2, and Sb3 of the client B CLNT_B by each of the transactions Tx1, Tx2, and Tx3, and a client K CLNT_K transitions to blockchain states Sk1, Sk2, and Sk3 of the client K CLNT K by each of the transactions Tx1, Tx2, and Tx3.

The apparatus 100 for finding the consensus bugs compares a blockchain state of each client by a series of transactions Tx1, Tx2, and Tx3, and determines consensus information based on the compared result. For example, the apparatus 100 for finding the consensus bugs may determine that the consensus bugs are triggered by the corresponding test case when a series of state transitions by the series of transactions Tx1, Tx2, and Tx3 are not matched.

On the other hand, initial blockchain states Sa0, Sb0, and Sk0 of the respective clients CLNT_A, CLNT_B, and CLNT_K may be provided to each client by the apparatus 100 for finding the consensus bugs. That is, the initial block chain state of each client may be determined according to the blockchain state determined by the apparatus 100 for finding the consensus bugs. That is, the initial blockchain states Sa0, Sb0, and Sk0 of the respective clients CLNT_A, CLNT_B, and CLNT_K are the same as each other.

Hereinafter, finding of consensus bugs according to an example embodiment will be described in detail.

FIG. 3 is a block diagram of an apparatus for finding consensus bugs according to an example embodiment.

The apparatus 100 for finding the consensus bugs is an electronic device including a processor 110 and a memory 120, and the processor 110 executes at least one instruction stored in the memory 120 to execute a process of finding consensus bugs according to an example embodiment.

For example, the apparatus 100 for finding the consensus bugs may be a computing device having the processor 110 such as a desktop, a PC, a mobile terminal, or a server device. For example, the apparatus 100 for finding the consensus bugs may be a standalone computing device or a distributed computing device, but is not limited thereto and may be implemented in various computing methods.

The processor 110 is a kind of central processing unit, and may control an operation of the apparatus 100 for finding the consensus bugs by executing one or more instructions stored in the memory 120.

The processor 110 may include all types of devices capable of processing data. The processor 110 may refer to, for example, a data processing device built in hardware, which includes physically structured circuits in order to perform functions represented as codes or instructions contained in a program.

As such, an example of the data processing device built in the hardware may include all processing devices, such as a microprocessor, a central processing unit (CPU), a processor core, a multiprocessor, an application-specific integrated circuit (ASIC), a field programmable gate array (FPGA), but is not limited thereto. The processor 110 may include one or more processors.

The memory 120 may store at least one instruction for executing the method for finding the consensus bugs according to the example embodiment.

The memory 120 may store a corpus including test cases, block list information, transaction information, blockchain state information, client program state information, and intermediate data and calculation results created in the process of finding the consensus bugs.

The memory 120 may include an internal memory and/or an external memory, and may include a volatile memory such as DRAM, SRAM, or SDRAM, a non-volatile memory such as one time programmable ROM (OTPROM), PROM, EPROM, EEPROM, mask ROM, flash ROM, NAND flash memory, or NOR flash memory, a flash drive such as SSD, compact flash (CF) card, SD card, micro-SD card, mini-SD card, Xd card, or a memory stick, or a storage device such as an HDD. The memory 120 may include magnetic storage media or flash storage media, but is not limited thereto.

Additionally, the apparatus 100 for finding the consensus bugs may further include a communication interface configured to transmit/receive data to/from an external device. For example, the apparatus 100 for finding the consensus bugs may receive a test case from an external device through a communication interface and transmit a bug detection result to the external device.

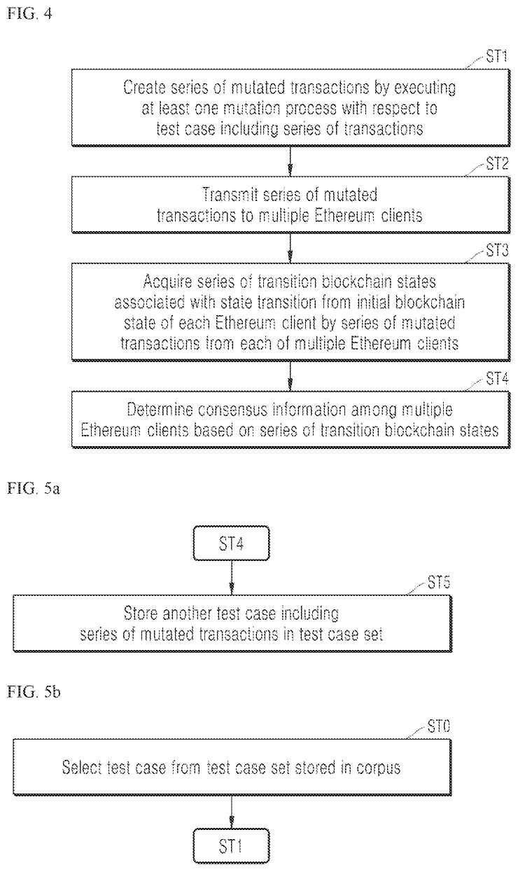

FIG. 4 is a flowchart of a method for finding consensus bugs according to an example embodiment.

The method for finding the consensus bugs according to the example embodiment includes creating, by the processor 110, a series of mutated transactions in which at least some of a series of transitions are altered by executing at least one mutation process with respect to a test case including the series of transactions (ST1), providing, by the processor 110, the series of mutated transactions to multiple Ethereum clients CLNTs (ST2), acquiring a series of transition blockchain states associated with a state transition from an initial blockchain state of each Ethereum client CLNT by the series of mutated transactions from each of the multiple Ethereum clients CLNTs (ST3), and determining consensus information among the multiple Ethereum clients CLNTs based on the series of transition blockchain states (ST4).

In step ST1, the processor 110 creates the series of mutated transactions in which at least some of the series of transitions are altered by executing at least one mutation process with respect to the test case including the series of transactions.

Step ST1 includes applying at least one mutation of a transaction context mutation, a transaction parameter mutation, and an EVM bytecode mutation.

The transaction context mutation randomly mutates a block list and a transaction list of the test case. The transaction parameter mutation mutates a transaction receiver address and the like. The EVM bytecode mutation mutates a constructor field and a code-to-return field of the contract creation transaction. Each mutation will be described below with reference to FIG. 8.

In step ST1, the processor 110 may apply at least one of the above-described three mutations to at least some of the series of transactions.

In step ST2, the processor 110 provides the series of mutated transactions created in step ST1 to the multiple Ethereum clients CLNTs.

For example, the processor 110 may provide the series of mutated transactions to the Ethereum clients through various types of communication interfaces between processes. For example, the processor 110 may transmit the series of mutation transactions to the Ethereum clients executing in an external device through the communication interface.

The multiple Ethereum clients CLNTs execute the series of mutated transactions provided by the apparatus 100 for finding the consensus bugs. The multiple Ethereum clients CLNTs sequentially transition the blockchain states from initial blockchain states to a series of transition blockchain states by the series of mutated transactions, respectively, and create code path information by the series of mutated transactions.

In step ST3, the processor 110 acquires the series of transition blockchain states associated with the state transition from the initial blockchain state of each Ethereum client CLNT by the series of mutated transactions from each of the multiple Ethereum clients CLNTs.

For example, the processor 110 may acquire the series of transition blockchain states from the Ethereum clients through various types of communication interfaces between the processes. For example, the processor 110 may receive the series of transition blockchain states from the Ethereum clients executing in an external device through the communication interface.

Step ST3 may include acquiring, by the processor 110, code path information by the series of mutated transactions. The processor 110 may acquire the code path information by the series of mutated transactions in each Ethereum client from the multiple Ethereum clients CLNTs in the same manner as the above-described method of acquiring the series of transition blockchain states.

In step ST4, the processor 110 may determine consensus information between the multiple Ethereum clients CLNTs based on the series of transition blockchain states. In step ST4, the processor 110 may determine whether the multiple Ethereum clients CLNTs have transitioned to the same blockchain state by the series of mutated transactions, respectively.

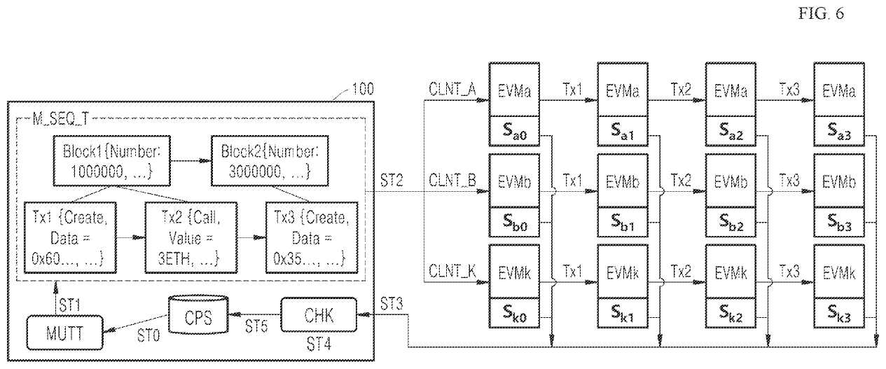

Step ST4 includes comparing, by the processor 110, the series of transition block states acquired in step ST3 from each Ethereum client in sequence, and determining a consensus result among the multiple Ethereum clients for the series of transactions based on such a comparison result. This will be described below with reference to FIG. 6.

Meanwhile, the consensus information, as information indicating whether state transitions of the multiple Ethereum clients CLNTs for the test cases are matched, includes, for example, crash information between the multiple Ethereum clients CLNTs.

Step ST4 may include tracking the crash information between the multiple Ethereum clients based on the code path information acquired in step ST3 by the processor 110. Here, the crash information may include, for example, mismatched transition blockchain state information and a code position causing the crash.

Additionally, the method for finding the consensus bugs may further include selecting a test case from a test case set stored in a corpus (ST0) and storing another test case including the series of mutated transactions in the test case set (ST5).

For example, when reaching the consensus in step ST4, the method according to the example embodiment may further include storing the series of mutated transactions in the corpus as another test case (ST5). In addition, the method may further include selecting a test case before step ST1 (ST0). This will be described with reference to FIGS. 5A and 5B.

Meanwhile, the method for finding the consensus bugs may be executed by iterating steps ST0 to ST5 by a predetermined number of times or for all test cases in the corpus.

FIG. 5A is an additional flowchart of a method for finding consensus bugs according to an example embodiment.

The method for finding the consensus bugs may further include storing another test case including the series of mutated transactions in the test case set (ST5) when reaching the consensus in step ST4, after step ST4.

FIG. 5B is an additional flowchart of a method for finding consensus bugs according to an example embodiment.

The method for finding the consensus bugs may further include selecting a test case from the test case set stored in the corpus (ST0) before step ST1. For example, the processor 110 may select a test case in a random manner or in a descending or ascending order of the number of transactions included in the test case, and may select a test case by various methods without being limited thereto.

FIG. 6 is a diagram for exemplarily describing finding of consensus bugs according to an example embodiment.

The apparatus 100 for finding the consensus bugs 100 operates as a multi-transaction differential fuzzer.

The apparatus 100 for finding the consensus bugs 100 may fully cover a search space for finding the consensus bugs by modeling the Ethereum client CLNT as a client program state model. In the client program state model, the apparatus 100 for finding the consensus bugs tests a series of multi-transactions at every iteration. In addition, the apparatus 100 for finding the consensus bugs uses multiple Ethereum clients as cross-reference oracles.

In step ST0, the processor 110 selects a test case from a corpus of previously executed test cases. The test case is a test unit used when the apparatus 100 for finding the consensus bugs executes the Ethereum client once, and one test case has many blocks. Here, the block is an Ethereum block, and one block records multiple transactions.

The corpus CPS is a storage of previously executed test cases, and a mutator MUTT is executed by the processor 110 in step ST1, and creates a new test case including a series of mutated transactions created by mutating the test cases.

A transaction Tx is to send Ethereum from one Ethereum account to another account, and when the received account is a smart contract, a code of the corresponding smart contract is executed.

Each test case contains information about multiple transactions and dependencies between the transactions.

In step ST1, the processor 110 mutates a series of transactions of the test case selected in step ST0 to create a series of mutated transactions M_SEQ_T.

Subsequently, multiple Ethereum clients (e.g., CLNT_A, CLNT_B, and CLNT_K) execute the series of mutated transactions M_SEQ_T.

While the multiple Ethereum clients (e.g., CLNT_A, CLNT_B, and CLNT_K) execute the transactions Tx1, Tx2, and Tx3 in the mutated test cases, the initial blockchain states Sa0, Sb0, and Sk0 transition to new blockchain states, that is, a series of transition blockchain states CLNT_A: (Sa1, Sa2, Sa3), CLNT_B: (Sb1, Sb2, Sb3), and CLNT_K: (Sk1, Sk2, Sk3).

When the execution is completed, the processor 110 collects new blockchain states and code coverage feedback from the multiple Ethereum clients (e.g., CLNT_A, CLNT_B, and CLNT_K) in step ST3. Here, the code coverage is statistical information about how many times the client state is searched.

In step ST4, the processor 110 may determine consensus information between the multiple Ethereum clients CLNTs based on the series of transition blockchain states.

In step ST4, the processor 110 cross-checks the blockchain states collected from different clients.

For example, when there are two clients CLNT_A and CLNT_B, the processor 110 determines whether the clients have transitioned to different states while executing (Sa1!=Sb1∥Sa2!=Sb∥Sa3!=Sb3), and determines consensus information accordingly. For example, when there are k clients CLNT_A, CLNT_B to CLNT_K, the

processor 110 determines whether each client has transitioned to a different state after a series of transactions and determines consensus information accordingly.

When the clients transition to different states, it is determined that crashes have occurred. If the clients have reached the same final blockchain state, it is determined that no consensus bugs have been found and step ST0 starts again.

In step ST5, when a new code path is found from the information collected in step ST3, the processor 110 stores new test cases including a series of mutated transactions in the corpus.

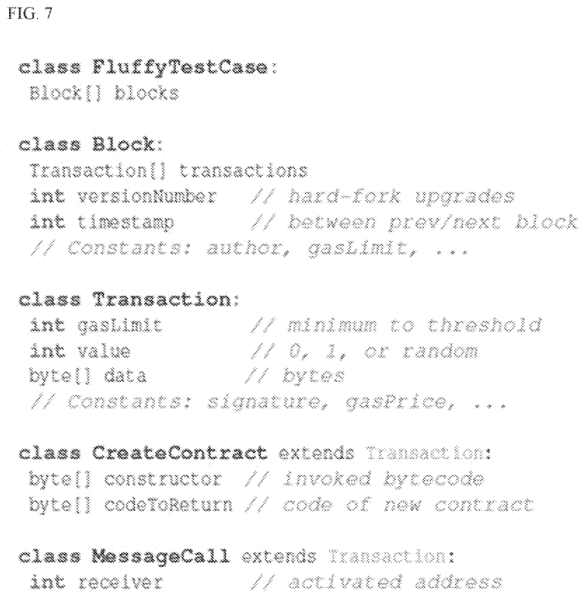

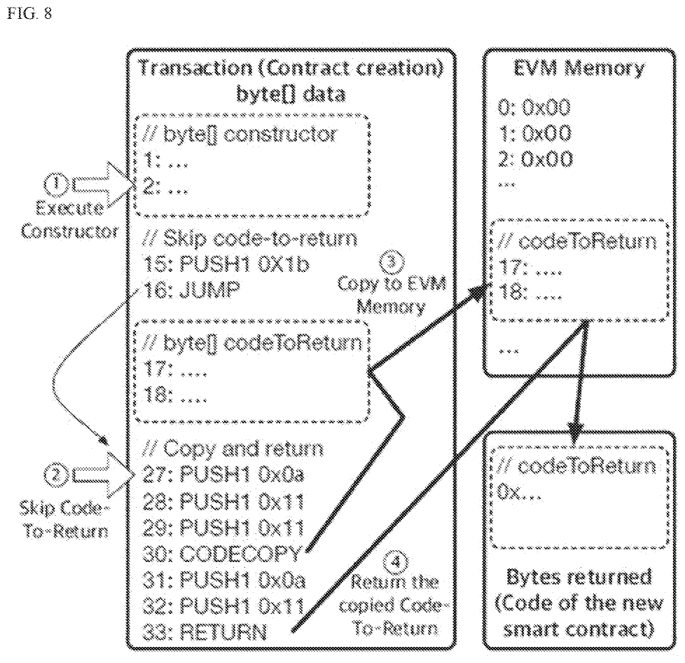

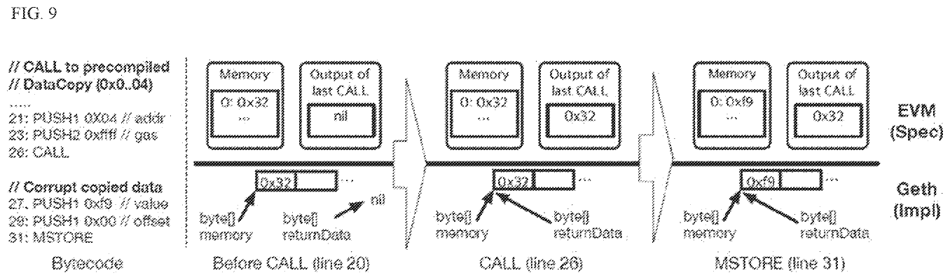

FIG. 7 illustrates a data structure of an exemplary test case for finding consensus bugs according to an example embodiment.

A test case (class FluffyTestCase) includes a list of blocks, and each block (class Block) includes a list of transactions.

That is, the processor 110 executes the transactions of each block in the list of blocks according to the order in each of the multiple Ethereum clients, and applies each transaction to the blockchain state to execute the test case.

### Test Case

One test case has multiple blocks, and each block has multiple transactions. When executing the test, the blocks and the transactions are executed on multiple Ethereum clients in list order.

Only major parameters in the Ethereum blocks and transactions are randomly created by designating specific candidate values. Non-mentioned parameters have appropriate constant values and are executed in the Ethereum clients.

In addition to the parameters, fuzzing is performed by randomly changing the

number of transactions and the number of blocks.

### Block

transactions: Record multiple transactions
version Number: As block version numbers, the version numbers at the time of hard-fork upgrades of Ethereum are used as candidates.
timestamp: As block timestamps, values between timestamps of front and back blocks are used as candidates.

### Transaction

gasLimit: gasLimit mainly determines an execution range of smart contract codes, but since too large gasLimit reduces the performance of fuzzers by executing meaningless (less buggy) contract instructions by executing a too large smart contract, candidate values are determined within a threshold. For example, the gasLimit prevents too much time from being required before executing a next test by getting caught up in a smart contract infinite loop for a long time when the test is executed once.
value: 0-value transactions which are corner cases are set to be more tested.
data: In existing fuzzing techniques, this parameter is set to random bytes, but in the present disclosure, the parameter is set differently according to CreateContract/MessageCall. (CreateContract is a transaction that creates a new smart contract, and MessageCall is a transaction that calls the created smart contract.)

### CreateContract Extends Transaction

A data parameter is created by combining the following two items.
constructor: A part that is executed when creating the smart contract, random EVM instructions are created.
code ToReturn: A part that is set as codes of the smart contract, random EVM instructions are created.

### MessageCall Extends Transaction

receiver: Smart contract address created in previous transactions (activated address)

Hereinafter, a mutation process for creating the mutated transactions in step S1 will be described with reference to FIG. 4.

### Transaction Context Mutation

The processor 110 may mutate transaction contexts. Here, the transaction contexts are defined as ordered sequences of transactions executed before the transaction.

The processor 110 may randomly mutate the list of blocks and the list of transactions in order to mutate the transaction contexts. The processor 110 may mutate the transaction contexts by the following four methods, that is, add, delete, clone, and copy.

For example, the processor 110 may add a new block or a new transaction to the list, or delete an existing one. Also, for example, the processor 110 may clone an existing block or transaction or copy the contents of a transaction to another block or transaction.

On the other hand, conventional fuzzers directly create a pre-transaction blockchain state and test a single transaction from the created pre-transaction blockchain state. For each such pre-transaction blockchain state, it is limited to testing only a single pre-transaction client program state.

However, the multi-transaction differential fuzzing method according to the example embodiment may create and test various pre-transaction client program states (e.g., account_a={ETH:0, deleted: false}), or account_a={ETH:3, deleted: true}) for each pre-transaction blockchain state (e.g., account A has 0 ETH).

This is because the Ethereum clients can change the values of client program parameters in various methods depending on which sequence of transactions are executed. As a result, it is possible to find a transfer-after-destruct bug that cannot be found by the conventional fuzzers, which will be described below with reference to FIG. 10. The bug in FIG. 10 requires testing the state of a specific pre-transaction client program state that cannot be created by the blockchain state transition method.

### EVM Bytecode Mutation

Referring to FIG. 7, contract creation transactions (class CreateContract) include a constructor and code-to-return fields for the contract creation transactions. Such a field, along with some injected instructions, becomes part of the data field of the transactions.

The processor 110 may mutate codes of the newly created smart contracts to be directly mutated in step ST1, which are set as a code-to-return when the transaction is completed. This will be described below with reference to FIG. 8.

Existing Ethereum fuzzers have not considered approaches such as EVM bytecode mutation because the fuzzers execute a single transaction per fuzzing iteration and do not invoke the codes of the smart contracts created by the transactions.

### Transaction Parameter Mutation

The processor 110 may mutate transaction parameters. The processor 110 limits possible values of transactions and block parameters in step ST1 to reduce wasting CPU cycles in meaningless mutations and execution. The processor 110 may also configure to allow the clients to use constant values for parameters that have a limited effect on a method for executing transactions. Accordingly, it is possible to reduce the overhead of mutating and executing multiple transactions.

For example, the processor 110 may simply set a transaction receiver address

to a random integer, assuming that target clients will convert the transaction receiver address to an active address.

For example, the processor 110 may set the gas limit to the sum of the minimum gas required for EVM not to reject the transaction before invoking any bytecode.

For example, the processor 110 may set a gas limit as a randomly created number in the range between 0 to a threshold to avoid long sequences of meaningless instructions such as an infinite while loop. For example, the processor 110 may set the threshold to 16 million gas that allows executing a CREATE instruction 50 times, which is the most expensive instruction that costs 32000 gas. The 16 million gas costs only around 0.8 ETH on the Ethereum mainnet as of August 2020. In case of a value, which determines the amount of ETH transferred by the transaction, the processor 110 may randomly select 0, 1, or a random integer.

The processor 110 may also randomly mutate the parameters of blocks. The processor 110 may mutate the block version number, which determines the version of EVM that executes the transaction. Since Ethereum launched in 2014, there has been around 10 non backward compatible EVM hard-fork upgrades that came into effect at particular block version numbers. The processor 110 may use the version numbers for the start of a new EVM hard-fork upgrade, rather than covering all of the block version numbers used in mainnet, which are more than 10 million as of August 2020.

FIG. 8 illustrates an exemplary mutation process for finding consensus bugs according to an example embodiment.

When a smart contract is created with CreateContract transaction, byte [ ] data is interpreted and executed as EVM instructions, and the RETURN bytes therefrom are stored as codes of the created smart contract. Therefore, it is important for byte [ ] data to RETURN meaningful bytes.

In the example embodiment, byte [ ] data of CreateContract transaction is configured by a combination of the constructor and codeToReturn as above. This combination helps create new contracts. Existing technologies do not use the above method because the existing technologies create any contracts while randomly creating the blockchain state itself. In contrast, since the present disclosure randomly creates multiple transactions, the next transaction calls the smart contract created by the previous transaction, so that it is important to facilitate the creation of a new contract in the above manner.

The components of byte [ ] data are as follows.
byte [ ] constructor: Use the created constructor as it is.
skip code-to-return: Skip codeToReturn by inserting EVM instructions.
byte [ ] codeToReturn: Use the created codeToReturn as it is.
Copy and return: Copy and return the code ToReturn part.

The CreateContract is executed as follows.
(1) Execute constructor: A constructor code is executed.
(2) Skip code-to-return: JUMP a Program Counter (PC) after codeToReturn.
(3) Copy to EVM memory: CODECOPY a code corresponding to code ToReturn in an EVM memory.
(4) Return the copied Code-To-Return: RETURN the copied corresponding code.

Through this, a newly created contract has codeToReturn as a code.

Referring to FIG. 8, the bytecode mutation will be described.

The processor 110 may mutate a constructor and code-to-return fields of contract creation transactions to mutate the bytecode.

Specifically, the processor 110 may randomly add, delete, mutate, and copy bytecode instructions to the constructor and the code-to-return fields of the contract creation transactions.

Among various EVM instructions, the processor 110 does not add PUSH instructions PUSH1 to PUSH32, which make EVM push some following bytes 1B to 32B in the corresponding fields onto an EVM stack, rather than interpreting and executing the bytes and the bytecode instructions. Such an approach enables preserving the semantics of bytecode instructions that are not directly modified by the processor 110 across mutations.

In FIG. 8, the processor 110 may update the data field using the mutated constructor and code-to-return.

The processor 110 concatenate the constructor, instructions to skip the execution of the code-to-return (JUMP), the code-to-return, instructions to copy the code-to-return to the EVM memory (CODECOPY), and instructions to return the copied bytecode (RETURN).

Thereafter, when the transaction is executed and the bytecode of the data field is invoked, the constructor is executed and the code-to-return is returned.

This bytecode mutation does not treat the data field as a single sequence of instructions, and does not mutate the data field as a whole to create smart contract constructors that return appropriate bytecodes.

When the bytecode mutation treats the data field as a single sequence of instructions, and mutates the data field as a whole, there is a problem that the created constructor is likely to prematurely terminate before invoking RETURN to return the bytecode, while the bytecode mutation according to the example embodiment alleviates this problem. In addition, appropriate bytes should be stored in the right region of the EVM memory before invoking RETURN, and a problem that the stored bytes are completely altered by a small mutation is alleviated.

In the example embodiment, the code of a smart contract is not always equal to the code-to-return field of the transaction that creates the contract. This is because errors such as EVM stack underflow may still occur during the execution of the constructor field of the transaction, and prevent the following injected instructions to copy and return the code-to-return.

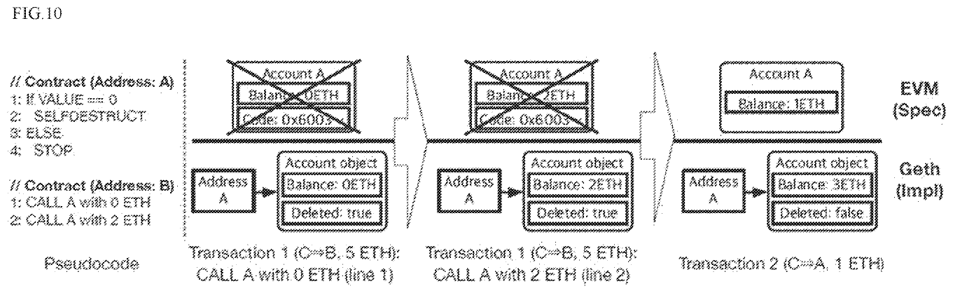

FIG. 9 is a diagram for describing an exemplary process of finding consensus bugs by the method for finding the consensus bugs according to the example embodiment.

FIG. 9 illustrates a test case and an operation process to find a shallow copy bug in Geth by the method for finding the consensus bugs according to the example embodiment.

An attacker may corrupt a precompiled DataCopy contract using the shallow copy bug and make Geth deviate from the EVM specification.

FIG. 10 is a diagram for describing an exemplary process of finding consensus bugs by the method for finding the consensus bugs according to the example embodiment.

FIG. 9 illustrates a test case and an operation process to find a Transfer-After-Destruct-Bug in Geth by the method for finding the consensus bugs according to the example embodiment.

Transaction 1 invokes B, which allows Call A to be executed twice. Transaction 2 invokes A. An attacker may use Transfer-After-Destruct-Bug to intercept the balance of a deleted account into a new account with the same address, which makes Geth to deviate from the EVM specification.

By extending this technology, this technology can be applied to other smart contract-based blockchain bug finding other than Ethereum (e.g., Cardano, Stellar, EOS, NEM, Tron, Tezos, and Neo).

The method according to the example embodiment of the present disclosure described above can be embodied as computer readable codes on a medium in which programs are recorded. That is, the method according to an example embodiment can be provided as a computer-readable non-transitory recording medium storing a computer program including at least one instruction configured to execute the method according to the example embodiment by a processor.

The computer readable non-transitory recording medium includes all kinds of recording devices storing data which are readable by a computer system. Examples of the computer readable non-transitory recording medium include a Hard Disk Drive (HDD), a Solid State Disk (SSD), a Silicon Disk Drive (SDD), a ROM, a RAM, a CD-ROM, a magnetic tape, a floppy disk, optical data storage devices, etc.

The aforementioned description of the present disclosure is illustrative, and it can be understood to those skilled in the art that the present disclosure can be easily modified in other detailed forms without changing the technical spirit or required features of the present disclosure. Therefore, it should be appreciated that the example embodiments described above are illustrative in all aspects and are not restricted. For example, respective components described as single types can be distributed and implemented, and similarly, components described to be distributed can also be implemented in a coupled form.

The scope of the present disclosure is represented by claims to be described below rather than the detailed description, and it is to be interpreted that the meaning and scope of the claims and all the changes or modified forms derived from the equivalents thereof come within the scope of the present disclosure.

Many modifications to the above example embodiments may be made without altering the nature of the disclosure. The dimensions and shapes of the components and the construction materials may be modified for particular circumstances. While various example embodiments have been described above, it should be understood that they have been presented by way of example only, and not as limitations.

1. A method for finding consensus bugs executed by an apparatus for finding consensus bugs including a processor, the method comprising:
creating, by the processor, a series of mutated transactions in which at least some of a series of transitions are altered by executing at least one mutation process with respect to a test case including the series of transactions;
providing, by the processor, the series of mutated transactions to multiple Ethereum clients;
acquiring a series of transition blockchain states associated with a state transition from an initial blockchain state of each Ethereum client by the series of mutated transactions from each of the multiple Ethereum clients; and
determining consensus information among the multiple Ethereum clients based on the series of transition blockchain states.

2. The method for finding the consensus bugs of claim 1, wherein each transaction in the series of transactions is a contract creation transaction that creates a smart contract or a message call transaction that calls a smart contract.

3. The method for finding the consensus bugs of claim 1, wherein the creating of the series of mutated transactions comprises applying at least one mutation of a transaction context mutation, a transaction parameter mutation, and an EVM bytecode mutation to at least some of the series of transactions.

4. The method for finding the consensus bugs of claim 3, wherein the applying of the at least one mutation comprises executing at least some of at least one instruction of add, delete, clone, and copy.

5. The method for finding the consensus bugs of claim 3, wherein the EVM bytecode mutation comprises at least one of a constructor mutation and a code-to-return mutation of the contract creation transaction.

6. The method for finding the consensus bugs of claim 1, further comprising:
selecting the test case from a test case set stored in a corpus; and
storing another test case including the series of mutated transactions in the test case set.

7. The method for finding the consensus bugs of claim 1, wherein the acquiring of the series of transition block states comprises acquiring code path information by the series of mutated transactions.

8. The method for finding the consensus bugs of claim 7, wherein the consensus information includes crash information between the multiple Ethereum clients, and the determining of the consensus information comprises tracking the crash information based on the code path information.

9. The method for finding the consensus bugs of claim 1, wherein the determining of the consensus information comprises
comparing the series of transition block states acquired from each Ethereum client in sequence; and
determining a consensus result among the multiple Ethereum clients for the series of transactions based on the comparison result.

10. The method for finding the consensus bugs of claim 1, wherein the multiple Ethereum clients are instances of an Ethereum virtual machine (EVM) implemented according to the Ethereum EVM specification, respectively.

11. An apparatus for finding consensus bugs comprising:
a memory configured to store at least one instruction; and a processor, wherein when the at least one instruction is executed by the processor, the processor is configured to
create a series of mutated transactions in which at least some of a series of transitions are altered by executing at least one mutation process with respect to a test case including the series of transactions,
provide the series of mutated transactions to multiple Ethereum clients, acquire a series of transition blockchain states associated with a state transition from an initial blockchain state of each Ethereum client by the series of mutated transactions from each of the multiple Ethereum clients, and
determine consensus information among the multiple Ethereum clients based on the series of transition blockchain states.

12. The apparatus for finding the consensus bugs of claim 11, wherein when the at least one instruction is executed by the processor, in order to create the series of mutated transactions,
the processor is configured to apply at least one mutation of a transaction context mutation, a transaction parameter mutation, and an EVM bytecode mutation to at least some of the series of transactions.

13. The apparatus for finding the consensus bugs of claim 12, wherein when the at least one instruction is executed by the processor, in order to apply the at least one mutation,
the processor is configured to execute at least some of at least one instruction of add, delete, clone, and copy.

14. The apparatus for finding the consensus bugs of claim 12, wherein the EVM bytecode mutation comprises at least one of a constructor mutation and a code-to-return mutation of the contract creation transaction.

15. The apparatus for finding the consensus bugs of claim 11, wherein when the at least one instruction is executed by the processor, the processor is configured to
select the test case from a test case set stored in a corpus, and
store another test case including the series of mutated transactions in the test case set.

16. The apparatus for finding the consensus bugs of claim 11, wherein when the at least one instruction is executed by the processor, in order to acquire the series of transition block states,
the processor is configured to acquire code path information by the series of mutated transactions.

17. The apparatus for finding the consensus bugs of claim 16, wherein the consensus information includes crash information between the multiple Ethereum clients, and
when the at least one instruction is executed by the processor, in order to determine the consensus information,
the processor is configured to track the crash information based on the code path information.

18. The apparatus for finding the consensus bugs of claim 11, wherein when the at least one instruction is executed by the processor, in order to determine the consensus information,
the processor is configured to compare the series of transition block states acquired from each Ethereum client in sequence, and
determine a consensus result among the multiple Ethereum clients for the series of transactions based on the comparison result.

19. The apparatus for finding the consensus bugs of claim 11, wherein the multiple Ethereum clients are instances of an Ethereum virtual machine (EVM) implemented to conform to the Ethereum EVM specification, respectively.

20. A computer-readable non-transitory recording medium for storing a computer program including at least one instruction configured to execute, by a processor, the method for finding the consensus bugs according to claim 1.
